(19) United States
(12) Patent Application Publication
(10) Pub. No.: US 2024/0391307 A1
(43) Pub. Date: Nov. 28, 2024

(54) TRUCK BED COVER SYSTEM AND METHODS OF USE

(71) Applicant: Paul Kaminga, West Roxbury, MA (US)

(72) Inventor: Paul Kaminga, West Roxbury, MA (US)

(21) Appl. No.: 18/673,622

(22) Filed: May 24, 2024

Related U.S. Application Data
(60) Provisional application No. 63/468,769, filed on May 24, 2023.

(51) Int. Cl. B60J 7/16

(52) U.S. Cl. CPC B60J 7/1607

(57) ABSTRACT

In accordance with the inventive concepts, provided is a truck bed cover system comprising a cover configured to couple to and enclose a truck bed volume of a truck bed. The cover comprises a first panel rotatably hinged to the cover and comprising at least one first access panel that is rotatably hinged to the first panel and a second panel rotatably hinged to the cover and comprising at least one second access panel that is rotatably hinged to the second panel. The first panel is configured to rotate away from a centerline of the truck bed volume and the second panel is configured to rotate away from the centerline of the truck bed volume in a direction opposite the first panel.

### CROSS REFERENCE TO RELATED APPLICATIONS

The present application claims priority under 35 USC 119 (e) to U.S. Provisional Patent Application 63/468,769, filed May 24, 2023, which is incorporated herein by reference.

### FIELD OF INTEREST

The present inventive concepts relate to the field of covers for external vehicle spaces and methods of use, such as truck bed covers.

### BACKGROUND

A truck bed cover, which is often referred to as a tonneau cover, may assist a user in securing and protecting items stored in a bed of a pickup truck. Truck bed covers generally come in one of two types, soft or hard. A soft cover can be unrolled to cover the bed and rolled to expose the bed. Alternatively, rigid truck bed covers can come in one or two types. A first type is a single-piece rigid coved that is hinged near the cab and can be lifted from the tailgate to open and then close again. A rigid cover can be foldable, such that it can be unfolded to cover the bed and folded toward the cab to reveal the bed. In either case, the bed can be completely covered by the truck bed cover.

Whether soft or rigid, truck bed covers cover the entirety of the truck bed with no opportunity to access the truck bed unless the cover is at least partially removed. In some circumstances, a user may want the ability to easily access a portion of the volume of the bed under a truck bed cover without entirely removing the cover, e.g., rolling or folding the cover back toward the bed.

### SUMMARY

In accordance with at least one aspect of the inventive concepts, provided is a truck bed cover system, comprising: a cover comprising at least one panel configured to enclose a truck bed volume of a truck bed; and the at least one panel including at least one access panel configured to selectively provide access to the truck bed volume when enclosed by the at least one panel.

In various embodiments, the at least one panel comprises a plurality of panels, wherein each of the plurality of panels covers a portion of the truck bed volume.

In various embodiments, the cover comprises a plurality of panels, at least one panel from the plurality of panels comprises a plurality of access panels.

In various embodiments, the system further comprises a securing mechanism for securing at least one of the plurality of panels to another one of the plurality of panels.

In various embodiments, the system further comprises a cover attachment mechanism constructed and arranged to removably couple the cover to the truck.

In various embodiments, one or more panels from the at least one panel is coupled to the cover via a rotatable attachment mechanism.

In various embodiments, one or more panels from the at least one panel is configured to rotate open relative to the cover toward a truck bed center.

In various embodiments, one or more access panels from the at least one panel is coupled to a corresponding access panel via a rotatable attachment mechanism.

In various embodiments, one or more access panels from the at least one access panel is configured to rotate open relative to its corresponding panel toward a truck bed center.

In various embodiments, the at least one access panel is removably coupled to the at least one panel.

In various embodiments, the at least one panel comprises at least one aperture and each access panel is configured to selectively cover a corresponding aperture.

In various embodiments, the at least one access panel comprises a securing mechanism configured to secure a position of the at least one access panel relative to the at least one panel.

In various embodiments, the cover forms a water-tight seal with the truck bed.

In various embodiments, the cover comprises a raised region near a center of the cover to move water towards the edges.

In various embodiments, the system further comprises at least one mount coupled to the at least one panel, each mount constructed and arranged to hold an accessory.

In various embodiments, the at least one panel includes a left panel and a right panel that rotate open outward from a centerline of the truck bed, each panel including at least one mount, wherein the accessory comprises a bar having a first end that couples to a mount of the left panel and a second end that couples to a mount of the right panel.

In various embodiments, the accessory comprises at least one storage rack.

In various embodiments, the accessory comprises at least one rail configured to receive at least one removable hook and/or at least one removable extender bar.

In various embodiments, the at least one panel comprises panel that includes a light.

In accordance with another aspect of the inventive concepts, provided is a truck bed cover system comprising a cover configured to couple to and enclose a truck bed volume of a truck bed. The cover comprises a first panel rotatably hinged to the cover and comprising at least one first access panel that is rotatably hinged to the first panel; and a second panel rotatably hinged to the cover and comprising at least one second access panel that is rotatably hinged to the second panel, wherein the first panel is configured to rotate away from a centerline of the truck bed volume and the second panel is configured to rotate away from the centerline of the truck bed volume in a direction opposite the first panel.

In accordance with at least one aspect of the present disclosure, a truck bed, or tonneau, cover system, comprises a cover configured to couple to a truck, the cover comprising at least one panel configured to enclose and selectively provide access to at least a portion of a truck bed volume; and at least one access panel coupled to the at least one panel and configured to selectively provide access to the truck bed volume when the cover at least partially encloses the truck bed volume.

In various embodiments, the cover comprises a first panel and a second panel, wherein the first panel covers half of the truck bed volume and the second panel covers half of the truck bed volume.

In various embodiments, the truck bed cover system comprises a securing mechanism for securing the first panel to the second panel.

In various embodiments, the cover comprises a handle.

In various embodiments, the first panel covers a left side of the truck bed volume and the second panel covers a right side of the truck bed volume.

In various embodiments, the cover is removably coupled to the truck.

In various embodiments, the truck bed cover system further comprises a cover attachment mechanism constructed and arranged to couple the cover to the vehicle.

In various embodiments, the cover is coupled to at least one side of the truck.

In various embodiments, the at least one access panel is removably coupled to at least one panel.

In various embodiments, the truck bed cover system further comprising an access panel attachment mechanism constructed and arranged to couple the at least one access panel to the at least one panel.

In various embodiments, the access panel attachment mechanism comprises a hinge.

In various embodiments, the at least one panel comprises at least one aperture and each of the at least one access panels covers a corresponding aperture.

In various embodiments, the at least one access panel is rotatably coupled to the at least one panel such that it opens about a first axis in a first axial direction.

In various embodiments, the at least one access panel comprises a lock for securing the position of at least one of the at least one access panel.

In various embodiments, the at least one access panel comprises a handle.

In various embodiments, the at least one access panel comprises a first access panel and a second access panel.

In various embodiments, the first access panel is rotatably coupled to the at least one panel such that it opens about a first axis in a first axial direction.

In various embodiments, the second access panel is rotatably coupled to the at least one panel such that it opens about the first axis in the first axial direction.

In various embodiments, the second access panel is rotatably coupled to the at least one panel such that it opens in a first axial direction about a second axis that is parallel to the first axis.

In various embodiments, the second access panel is rotatably coupled to the at least one panel such that it opens in a second axial direction about a second axis that is parallel to the first axis.

In various embodiments, the second access panel is rotatably coupled to the at least one panel such that it opens about a second axis in a second axial direction.

In various embodiments, at least one of the first access panel or the second access panel comprises a lock for securing its position.

In various embodiments, at least one of the first access panel or the second access panel comprises a handle.

In various embodiments, the cover forms a water-tight seal with the truck.

In various embodiments, the cover comprises a raised region near the center to move water towards the edges.

In various embodiments, the cover comprises a first end and a second end; the first end being raised relative to the second end.

In various embodiments, the cover comprises a first end and a second end, the access panel being positioned near the first end and the center of the cover.

### BRIEF DESCRIPTION OF THE DRAWINGS

Aspects of the present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A is a top view of an embodiment of a truck bed cover system, in accordance with aspects of inventive concepts.

FIG. 1B is a top view of another embodiment of a truck bed cover system, in accordance with aspects of inventive concepts.

FIG. 1C is a top view of another embodiment of a truck bed cover system, in accordance with aspects of inventive concepts.

FIG. 2A is a side view of the truck bed cover system of FIG. 1A, in accordance with aspects of inventive concepts.

FIG. 2B is a side view of the truck bed cover system of FIG. 1B, in accordance with aspects of inventive concepts.

FIG. 3A is a rear view of the truck bed cover system of FIG. 1A, in accordance with aspects of inventive concepts.

FIG. 3B is a side perspective view of one panel of the truck bed cover system of FIG. 1A, in accordance with aspects of inventive concepts.

FIG. 3C is a perspective view of a cover portion of the truck bed cover system of FIG. 1A, in accordance with aspects of inventive concepts.

FIG. 4A is a rear view of the truck bed cover system of FIG. 1A, in accordance with aspects of inventive concepts.

FIG. 4B is a rear view of the truck bed cover system of FIG. 1B, in accordance with aspects of inventive concepts.

FIG. 4C is a rear view of the truck bed cover system of FIG. 1C, in accordance with aspects of inventive concepts.

FIG. 5 is a perspective view of an embodiment of a support brace, a rail, and a cover attachment mechanism of a truck bed cover system, in accordance with aspects of inventive concepts.

FIG. 6 is a perspective view of an embodiment of the hinge of the cover attachment mechanism of FIG. 5, in accordance with aspects of inventive concepts.

FIG. 7 is a perspective view of an embodiment of a cover attachment mechanism used to couple a main panel to a truck, in accordance with aspects of inventive concepts.

FIG. 8 is a top view of an embodiment of a rail of FIG. 5 comprising a channel, in accordance with aspects of inventive concepts.

FIG. 9 is a cutaway end view of an embodiment of the rail of FIGS. 5 and 8, in accordance with aspects of inventive concepts.

FIG. 10 is a perspective view of an embodiment of an adjustable mount of a truck bed cover system, in accordance with aspects of inventive concepts.

FIG. 11A is a perspective view of a bar coupled to at least one adjustable mount of a truck bed cover system, in accordance with aspects of inventive concepts.

FIG. 11B is a rear view of the bar of FIG. 11A extending across the truck bed, in accordance with aspects of inventive concepts.

FIG. 12 is a rear view of an embodiment of a mount coupled to a rear end or edge of a panel, in accordance with aspects of inventive concepts.

FIG. 13 is a rear perspective view of an embodiment of a truck bed cover system, in accordance with aspects of inventive concepts.

FIG. 14 is a rear perspective view of an embodiment of a truck bed cover system, in accordance with aspects of inventive concepts.

FIG. 15 is a rear view of an embodiment of a truck bed cover system, in accordance with aspects of inventive concepts.

FIG. 16 is a side view of an embodiment of a truck bed cover system, in accordance with aspects of inventive concepts.

FIG. 17 is a side view of an embodiment of a truck bed cover system, in accordance with aspects of inventive concepts.

FIG. 18 is a rear view of an embodiment of a truck bed cover system, in accordance with aspects of inventive concepts.

FIG. 19 is a top view of an embodiment of a detachable access panel of the cover system, in accordance with aspects of inventive concepts.

FIG. 20 is a perspective view of an embodiment of a truck bed cover system, in accordance with aspects of inventive concepts.

FIG. 21 is a side view of an embodiment of a rack for storing one or more items, in accordance with aspects of inventive concepts.

FIG. 22 is a top view of a bed extender cover, in accordance with aspects of inventive concepts.

FIG. 23 is a perspective view of a bed extender cover and bed extender side covers of FIG. 22, in accordance with aspects of inventive concepts.

### DETAILED DESCRIPTION OF EXEMPLARY EMBODIMENTS

Various aspects of the inventive concepts will be described more fully hereinafter with reference to the accompanying drawings, in which some exemplary embodiments are shown. Aspects of the present inventive concepts may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

A truck bed cover may assist a user in securing and/or protecting items stored in a a truck bed volume of a vehicle, such as a pickup truck. A user may want the ability to easily access a portion of the volume under a truck bed cover without removing or fully opening the cover.

Systems and methods described herein relate to a truck bed cover system, that comprises a cover configured to couple to a truck, the cover comprising at least one panel configured to enclose and selectively provide access to at least a portion of a truck bed volume; and at least one access panel coupled to the at least one panel and configured to selectively provide access to the truck bed volume when the cover and/or panel at least partially or fully encloses the truck bed volume.

Systems and methods described herein facilitate easy access to items secured in the truck bed volume, without simultaneously exposing the entire truck volume. In some embodiments, systems and methods described herein also protect items stored in a truck bed volume from environmental conditions, such as rain, snow, etc.

Systems and methods described herein facilitate easy access to items secured in a portion of the truck bed volume, while maintaining coverage of items in other areas of the truck bed volume. As a result, for example, at least one portion of the truck bed volume can be open for access while other portions of the truck remain covered and protected, e.g., from environmental elements.

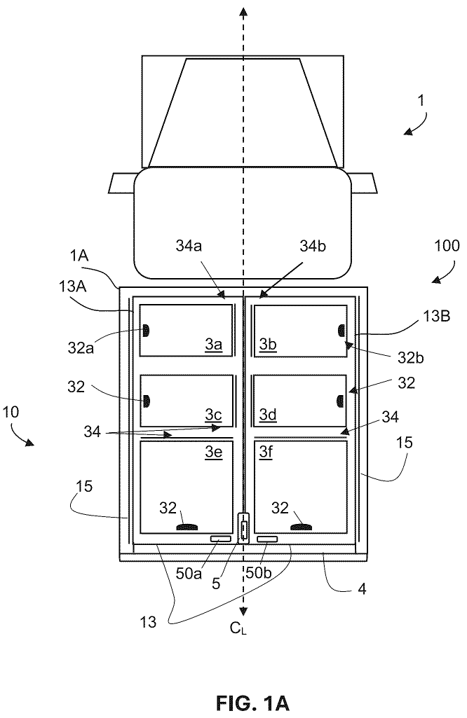

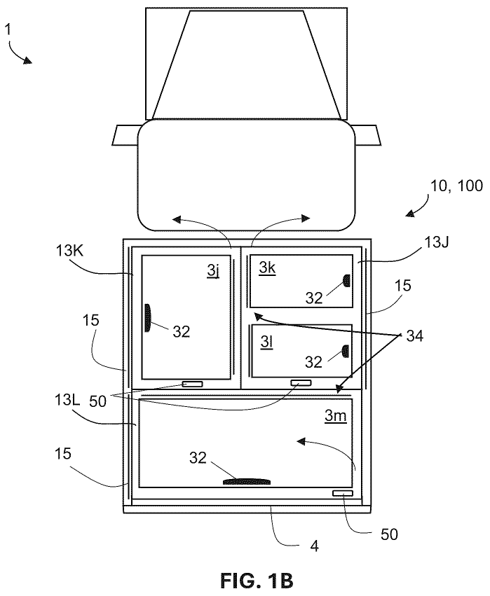

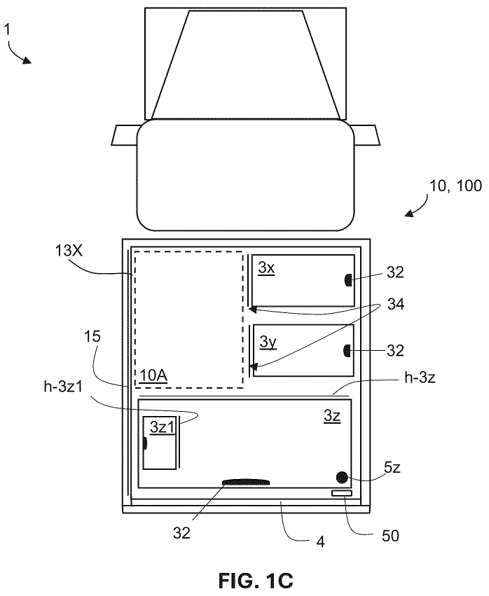

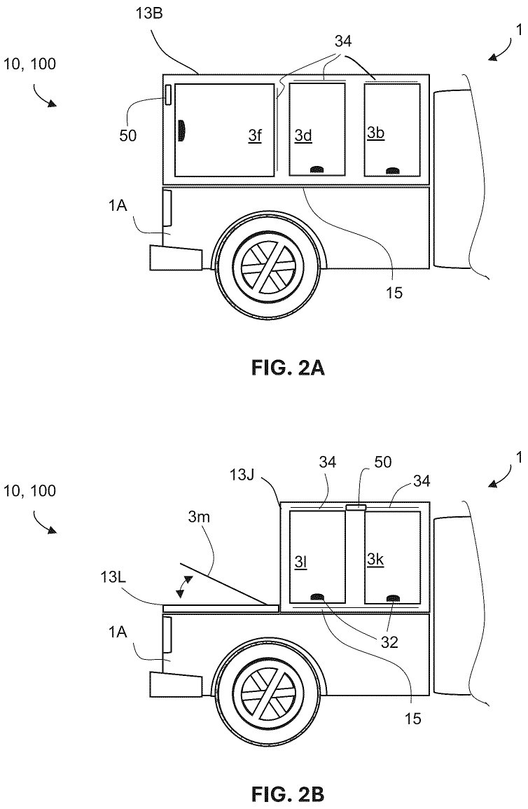

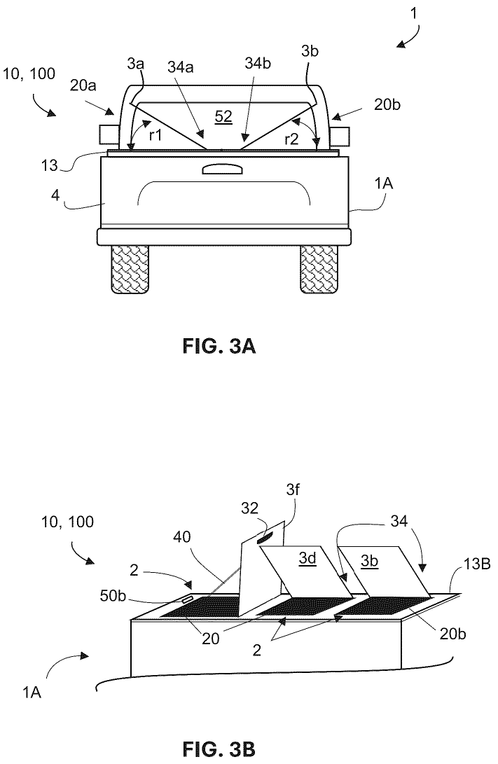

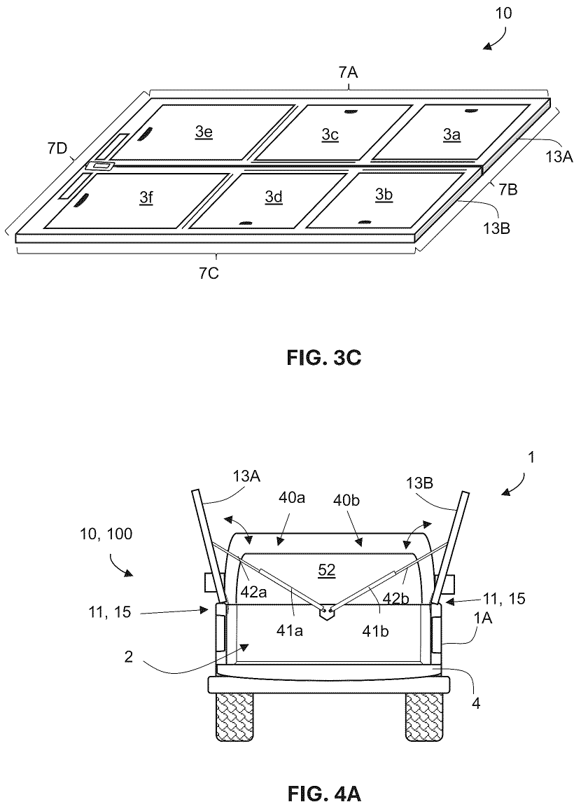

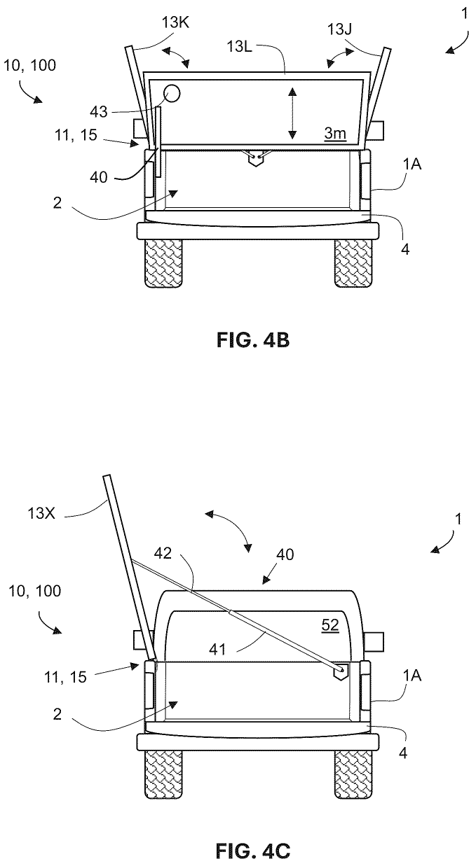

FIG. 1A is a top view of an embodiment of a truck bed cover system, in accordance with aspects of inventive concepts. FIG. 1B is a top view of another embodiment of a truck bed cover system, in accordance with aspects of inventive concepts. FIG. 1C is a top view of yet another embodiment of a truck bed cover system, in accordance with aspects of inventive concepts. FIG. 2A is a side view of the truck bed cover system of FIG. 1A, in accordance with aspects of inventive concepts. FIG. 2B is a side view of the truck bed cover system of FIG. 1B, in accordance with aspects of inventive concepts. FIG. 3A is rear view of the truck bed cover system of FIG. 1A, in accordance with aspects of inventive concepts. FIG. 3B is a side perspective view of one panel of the truck bed cover system of FIG. 1A, in accordance with aspects of inventive concepts. FIG. 3C is a perspective view of a cover portion of the truck bed cover system of FIG. 1A, in accordance with aspects of inventive concepts. FIG. 4A is a rear view of the truck bed cover system of FIG. 1A, in accordance with aspects of inventive concepts. And FIG. 4B is a rear view of the truck bed cover system of FIG. 1B, in accordance with aspects of inventive concepts. And FIG. 4C is a rear view of the truck bed cover system of FIG. 1C, in accordance with aspects of inventive concepts.

In each embodiment, the vehicle is a pick-up truck 1 having a truck bed 1A defined by vertical sides and a tailgate 4 that opens and closes, as is known in the art. The truck bed 1A defines a volume 2, typically used for storing items for transport. In various embodiments, a cover system is added to the truck bed to enclose the truck bed volume, while also allowing selective access to portions of the truck bed volume while a cover of the cover system is closed.

The figures show embodiments of the cover system 100 coupled to or otherwise forming part of the bed 1A of the truck 1. The truck bed cover system 100 comprises a cover 10 and can further include at least one panel. In some embodiments, such as the those shown in FIGS. 1A-4C, the cover system can comprise one or more main panels 13 configured to enclose the volume 2 of the truck bed 1A. A main panel can include one or more access panels configured to selectively allow access to a portion of the enclosed volume while its respective main panel(s) is/are closed. That is, each access panel can allow access to a portion of the volume while the volume is enclosed by the one or more main panels. A main panel can also be configured to selectively open and close, thereby selectively providing access to the truck bed volume 2 by opening a main panel. In some embodiments, the one or more main panels can be maintained, or fixed, in open position(s) such that the truck bed volume 2 is fully accessible.

In various embodiments, the cover 10 is a substantially planar cover that is an alternative to a traditional tonneau cover. It provides a substantially flat truck bed cover that is disposed on top of the four sides and tailgate 4 that define four vertical walls of the truck bed and of the truck bed volume 2. Unlike traditional tonneau covers, a cover in accordance with aspects of the inventive concepts includes one or more panels allowing access to the truck bed volume while the cover is closed. A closed position is when the cover encloses the truck bed volume.

In the embodiment shown in FIGS. 1A-4C, the cover 10 is dimensioned to fully cover the truck bed volume 2 by having four perimeter edges 7A-7D (see FIG. 3C) of the cover that are disposed on and/or coupled to the four edges of the three truck bed walls of the truck bed and a top of the closed tailgate. In the embodiment shown, the cover 10 has a rectangular shape defined by its four perimeter edges 7A-7D. When all panels, i.e., main panels and access panels, are closed the truck bed volume 2 is enclosed.

In alternative embodiments, the truck bed cover system 100 could be mounted to a different type of vehicle having a different volume. In those embodiments in which a different vehicle is involved, the dimensions of the cover 10 can be determined such that a volume that is otherwise externally accessible may be enclosed by the cover 10 when the cover system 100 is coupled to or otherwise forms part of the vehicle, with selective access to portions of the enclosed volume via at least one access panel. Additionally, or alternatively, the cover system can be sized and dimensioned to enclose a portion of an external volume, e.g., a portion of a truck bed volume, while leaving other portions of the external volume uncovered. In various embodiments, the cover system 100 is substantially planar with no vertical walls or compartments, as shown in FIG. 3C.

In various embodiments, such as those of FIGS. 1A, 1B, 1C, the cover 10 and the cover system 100 can comprise a plurality of panels. In various embodiments, all panels of the cover 10 can be substantially planar and the cover 10 can be substantially planar. In various embodiments, the cover can include at least one main panel 13. In various embodiments, the cover and cover system can include a plurality of main panels, such as panels 13A, 13B of FIG. 1A or panels 13J, 13K, 13L of FIG. 1B, as examples. A panel that forms part of another panel, e.g., a panel 3 forming part of a main panel 13, can be referred to as an access panel. Main panels and access panels may both be referred to as panels. In various embodiments, an access panel can include one or more access panels, e.g., as shown in FIG. 1C.

In the embodiment of FIG. 1A, 2A, 3A-3C, 4A, the cover 10 is a 50/50 cover, having two main panels 13A, 13B of the same size, or approximately the same size. In this embodiment, main panels 13A, 13B are disposed on each side of a centerline C_{L} longitudinally dividing the truck 1 and truck bed 10, thereby forming the 50/50 cover. In this embodiment, the main panels 13A, 13B rotate open away from each other and away from the centerline C_{L} of the truck bed, toward the side panels of the truck bed. In other embodiments, the cover 10 need not be a 50/50 cover having two main panels of the same size divided along a centerline C_{L}. Other ratios for dividing two panels can be used, such as 60/40, 70/30, 80/20, 90/10, or some other division, whether divided longitudinally, laterally, diagonally, in a combination thereof, or in some other manner. In some embodiments, there may be one main panel (e.g., see FIG. 1C) or more than 2 main panels (e.g., see FIGS. 1A and 1B).

In the embodiment of FIG. 1A, the cover 10 includes a plurality of access panels 3a, 3b, 3c, 3d, 3e, and 3f. The first main panel 13A includes the first, third, and fifth access panels 3a, 3c, 3e, positioned over a left side of the truck bed 1A relative to the centerline C_{L}. The second main panel 13B includes the second, fourth and sixth access panels 3b, 3d, and 3f, positioned over a right side of the truck bed 1A relative to the centerline C_{L}.

In some embodiments, such as the one shown in FIG. 1A, the first, second, third and fourth access panels 3a, 3b, 3c, 3d are of the same or similar size. In alternative embodiments, the first, second, third and/or fourth access panels 3a, 3b, 3c, 3d may be different sizes. Also, in the embodiment of FIG. 1A, the fifth and sixth access panels 3e, 3f are the same size, but are larger than the first through fourth access panels 3a, 3b, 3c, 3d. There is no inherent limitation on the sizes of the panels and whether or not they are the same size or different sizes.

In alternative embodiments, the cover 10 may comprise a different number and orientation of main panels 13 and/or access panels 3. For example, in various embodiments, the cover 10 can include one main panel 13 and one access panel 3, a plurality of main panels 13, but only one access panel 3, or one main panel 13 and a plurality of access panels 3, as examples. When there are a plurality of main panels 13 and/or access panels 3, the main panels and/or the access panels can be different sizes and oriented to open and close in different directions relative to the cover 10 and/or each other.

In alternative embodiments, the access panel(s) 3 may be arranged differently. For example, a first access panel 3 may be configured to be positioned to cover a top front region of the truck bed volume 2 and a second access panel may be configured to cover a rear region of the truck bed volume 2. In alternative embodiments, the first access panel and the second access panel may be configured to be positioned differently.

In still other embodiments, the cover 10 could additionally, or alternatively, include a plurality of main panels having at least one lateral divide across the truck bed and at least one longitudinal divide of the truck bed. An embodiment is shown in FIGS. 1B, 2B, 4B. When there is at least one lateral divide and at least one longitudinal divide, the cover may include at least three main panels.

Referring to the example embodiment of FIGS. 1B, 2B, and 4B, in this embodiment the cover 10 includes a plurality of main panels 13 comprising at least one lateral divide across or transverse to the truck bed 1A. Here, the cover 10 includes main panel 13L which is divided across, or transverse to, the truck bed 1A. In this embodiment, main panels 13J, 13K cover a front portion of the truck bed, and are longitudinally divided, while main panel 13L covers a rear portion of the truck bed. Main panels 13J, 13K include a plurality of access panels 3j, 3k, 3l, which provide access to front right and left sides of the front volume of the truck bed volume 2. Main panel 13L includes a single access panel 3m that provides access to the rear portion of the truck bed volume 2.

In FIG. 1B and main panel 13J has two access panels 3k, 3l that are the same or substantially the same size. But the access panels of the main panels 13K and 13L are different sizes. In FIG. 2B, main panel 13J is open, but main panel 13L is closed. Access panel 3m of main panel 13L is open.

FIGS. 1C and 4C show an embodiment with one main panel 13X having three access panels 3x, 3y, 3z, where access panels 3x and 3y are the same size and access panel 3z is a different, here larger, size. In some embodiments, the cover 10 may include one or more portions that do not open, with no access from an access panel or through the main panel, covering the one or more portions of the volume unless and until the main panel is opened. In the cover 10 of FIG. 1C, a portion of the main panel indicated as dashed box 10A is a solid panel with no access panel access or door. There are no inherent limitations on the number or proportioning of the main panels and/or access panels.

In some embodiments, as noted above, an access panel 3 can comprise one or more of its own access panels. FIG. 1C shows an example where main panel 13X includes access panel 3z which includes its own access panel 3z1. Access panel 3z can include a hinge h-3z that enables the access panel to open and close relative to the main panel 13X. Access panel 3z1 can include a hinge h-3z1 that enables the access panel 3z1 to rotate relative to access panel 3z. Access panels 3z and 3z1 are shown as being configured to open in different directions. In other embodiments, the access panel within an access panel could be configured to open in the same direction or in opposite directions.

The cover 10 and/or its panels 3, 13 may be comprised of any material suitable for protecting items located in a truck bed volume 2. In some embodiments, the panels may comprise or be formed from a rigid material. In some embodiments the panels may be formed of a flexible material. As examples, such materials may include, but are not limited to plastic, glass, carbon fiber, aluminum, a fiberglass-reinforced polymer, vinyl, rubber, wood, etc. In some embodiments, different portions of the cover 10 comprise different materials. For example, in some embodiments, different panels of the cover 10 can comprise different materials.

In some embodiments, such as the one shown in FIGS. 1A-4C, the cover 10 covers a top side of the truck bed volume 2 and the other sides of truck bed volume 2 are enclosed by side panels of the truck 1. In alternative embodiments, the truck 1 may enclose fewer sides of the truck bed volume 2. In such embodiments, the cover 10 may include one or more side panels that enclose more sides of the truck bed volume 2. In various embodiments, such side panels can be vertical panels.

In some embodiments, the cover 10 forms a water-tight seal with the truck bed 1A. In some embodiments, the joint formed between the main panels, e.g., the left and right main panels 13A, 13B of FIG. 1A, makes a watertight seal and/or an airtight seal between the main panels. In various embodiments, the main panels are hinged for rotation relative to the truck bed 1A to open and close. In various embodiments, the cover is hinged for rotation relative to the truck bed 1A to enable the cover to open and close. In some embodiments, the cover 10 is configured to be detachable from the truck bed, e.g., with locks, bolts, clips, snap, clasps, or other detachable mechanisms.

In some embodiments, the cover system can include at least one securing mechanism configured to secure together one or more main panels together and/or one or more main panels to the cover or cover system and/or to secure the cover to the cover system, and/or to secure the cover and/or one or more main panels to the truck or truck bed, and/or to secure the cover system to the truck and/or truck bed.

As an example, in the embodiment of FIG. 1A, the truck bed cover system 100 comprises a securing mechanism 5 configured to secure the first main panel 13A to the second main panel 13B. In the embodiment shown in FIG. 1A, the securing mechanism 5 comprises a lock. In alternative embodiments, the securing mechanism 5 may comprise a latch, rope, screws, or any suitable mechanism for securing two panels together. In some embodiments, such as the one shown in FIG. 1A, the securing mechanism 5 positioned at a rear end of the cover 10 (near the rear of the truck bed volume 2), for easy access. In alternative embodiments, the securing mechanism 5 is configured to be positioned at a front end of the cover 10 (near the front of the truck bed volume 2). In some embodiments, the truck bed cover system 100 comprises multiple securing mechanisms 5. In some embodiments, the truck bed cover system 100 comprises a securing mechanism 5 at the front end of the cover 10 and a securing mechanism 5 at the rear end of the cover 10; in some embodiments those locking mechanisms are operatively coupled together such that locking/unlocking one of them also locks/unlocks the other.

In some embodiments, at least one of the at least one access panels 30 comprises a lock for securing the position of the at least one access panel. For example, FIG. 1C shows access panel 3z having a lock 5z.

When a lock is included, such as lock 5 and/or 5x, the lock can be or any of a variety of types of known locks, such as a key lock or combination lock, a pad lock or a built-in lock, a magnetic lock or electromechanical lock, as examples.

In some embodiments, the truck bed cover system 100 comprises at least one access panel attachment mechanism constructed and arranged to couple an access panel to a respective main panel of the cover. In some embodiments, at least one access panel is rotatably coupled to at least one main panel. In various embodiments an access panel attachment mechanism comprises one or more hinges. In some embodiments, the access panel attachment mechanism comprises one or more detachable hinges. In alternative embodiments, the access panel attachment mechanism may comprise alternative attachment mechanisms. For example, in some embodiments, the access panels can slide open and closed relative to the main panel. In other embodiments, one or more of the access panels may be configured to detach relative to its main panel and/or the cover.

In the embodiments shown in FIG. 1A-4C, the truck bed cover system 100 comprises at least one access panel attachment mechanism 34 for each access panel 3. The access panel attachment mechanism 34 can be constructed and arranged to couple at least one access panel 3 to at least one main panel 13. In some embodiments, at least one access panel 3 is removably coupled to at least one main panel 13. In some embodiments the at least one access panel 3 is slidingly coupled to the at least one main panel 13.

In some embodiments, such as the one shown in FIGS. 1A-4C, in which an access panel 3 is rotatably coupled to a main panel 13, the access panel attachment mechanism 34 comprises one or more hinges. In some embodiments, the access panel attachment mechanism 34 comprises one or more detachable hinges. In some embodiments, the at least one access panel 3 is rotatably coupled to the at least one main panel such that it opens about a first axis in a first axial direction. In some embodiments, the first axis is aligned with the long or longitudinal axis of the vehicle. In some embodiments, the first axis is parallel with the longitudinal (front to back) axis of the vehicle. In some embodiments, the first axis is orthogonal (or transverse or lateral) to the long axis of the vehicle. In some embodiments, the first axis is at an acute angle with the longitudinal axis of the vehicle. In some embodiments, the first axis is at an obtuse angle with the longitudinal axis of the vehicle.

In some embodiments, the at least one access panel comprises a first access panel and a second access panel. In some embodiments, the first access panel is rotatably coupled to a main panel such that it opens about a first axis in a first axial direction. In some embodiments, the second access panel is rotatably coupled to the main panel such that it also opens about the first axis in the first axial direction. FIGS. 1A, 1B, 1C show examples of this with access panels 3b and 3d, 3a and 3c; 3k and 3l; and 3x and 3y.

In some embodiments, the second access panel is rotatably coupled to at least one panel such that it opens in the first axial direction about a second axis that is parallel to the first axis. In some embodiments, the second access panel is rotatably coupled to at least one panel such that it opens in a second axial direction about a second axis that is parallel to the first axis. In some embodiments, the second access panel is rotatably coupled to at least one panel such that it opens about a second axis in a second axial direction.

In some embodiments, the second axis is aligned with the longitudinal axis of the vehicle. In some embodiments, the second axis is parallel with the longitudinal axis of the vehicle. In some embodiments, the second axis is at an acute angle with the long axis of the vehicle. In some embodiments, the second axis is at an obtuse angle with the long axis of the vehicle. In some embodiments, the second axis is orthogonal with the longitudinal axis of the vehicle. FIGS. 1A, 1C show examples of this with access panels 3f rotational about an axis that is orthogonal to the rotation of axis of access panels 3b and 3d, 3a and 3c; and with access panels 3z rotational about an axis that is orthogonal to the rotation of axis of access panels 3x and 3y.

In various embodiments, one or more of the main panels 13 comprises at least one aperture 20 covered by an access panel 3. In the embodiment shown in FIGS. 1A, 3A and 3B, the first main panel 13A comprises an aperture 20a and a first access panel 3a is constructed and arranged to allow selective access through the aperture 20a and into the truck bed volume 2. The access panel 3a is coupled to the first main panel 13A using an access panel attachment mechanism 34a that comprises at least one hinge. The access panel 3a is constructed and arranged to open about a first axis that is parallel with a longitudinal axis of the truck. The first access panel 3a is constructed and arranged to open by rotating the first access panel 3a in a first rotational direction r1.

In the embodiment shown in FIGS. 1A, 3A and 3B, the second main panel 13B comprises an aperture 20b and a second access panel 3b is constructed and arranged to allow selective access through the aperture 20b and into the truck bed volume 2. The access panel 3b is coupled to the second main panel 13B using an access panel attachment mechanism 34b that comprises at least one hinge. The access panel 3b is constructed and arranged to open about a second axis that is parallel with a longitudinal axis of the truck and the first axis. The second access panel 3b is constructed and arranged to open by rotating the second access panel 3b in a second rotational direction r2, which is opposite the first rotational direction r1 in this embodiment.

FIG. 3B shows main panel 13B of the cover of FIG. 1A. The access panels 3b, 3d, and 3f are shown open, revealing a plurality of respective apertures 20 providing access to the truck bed volume 2. The access panels 3 of the cover system 100 embodiments of FIGS. 1B and 1C can similarly open to reveal apertures providing access into the enclosed volume.

In some embodiments, the sizes of the access panels 3 correspond to or are substantially the same as sizes of respective apertures 20. In some embodiments, the size and dimensions of an access panel 3 matches the size and dimensions of the corresponding aperture 20, such that the access panel 3 covers the corresponding aperture 20. In some embodiments, the size and dimensions of an access panel 3 are greater than the size and dimensions of the corresponding aperture 20, such that the access panel 3 covers more than the corresponding aperture 20. For example, in various embodiments, the access panel 3 can be 0.25 inches-1 inch greater in at least one dimension than the corresponding aperture 20. In some embodiments, the access panel 3 can be 0.25 inches-1 inch greater in each dimension than the corresponding aperture 20.

In some embodiments, at least one access panel 3 comprises a handle mechanism 32. In some embodiments, the handle mechanism 32 is a handle that extends from the access panel 3, e.g., a serves as grip. In some embodiments, such as the one shown in FIG. 1A, the handle mechanism 32 may comprise an aperture or depression in the access panel 3 that allows a user to grip the access panel 3 in order to lift open or otherwise move the access panel, as with access panels 3a, 3b, 3c, 3d.

In some embodiments, none of the access panels 3 comprise a handle mechanism 32. In some embodiments, some of the access panels 3 comprise a handle mechanism 32. In the embodiment shown in FIG. 1A, the first access panel 3a comprises a handle mechanism 32a and the second access panel 3b comprises a handle mechanism 32b. In the embodiment shown in FIG. 1A the handle mechanism 32a is at an end of the access panel 3a opposite its attachment mechanism 34a. In alternative embodiments, the handle mechanism 32 may be at a different location at the access panel 3a.

In some embodiments, one or more of the main panels 13 comprises at least one handle 50. In the embodiment shown in FIG. 1A, the first main panel 13A comprises a handle 50a. In the embodiment shown in FIG. 1A, the second main panel 13B comprises a handle 50b. Handles 50a, 50b can, in some embodiments, extend from their respective main panels 13A, 13B. In alternative embodiments, each of the main panels 13 can comprise a different number of handles 50 and/or one or more of the handles 50 can be in a different position.

In some embodiments, at least one of the main or access panels may be adjusted to the raised position manually using a handle mechanism, e.g. handle 32 or 50. Additionally or alternatively, in some embodiments, the truck bed cover system 100 comprises a power opening system configured to manipulate at least one of the panels between an open position and a closed position. In some embodiments, the power opening system operates using air springs. In some embodiments, the power opening system operates using hydraulics. In some embodiments, the power opening system operates using nitrogen. In some embodiments, the power opening system uses any technique suitable for opening and closing the main or access panels. In some embodiments, the power opening system includes at least one motor operatively coupled to a main panel or access panel via at least one linkage, which can include one or more gears, wheels, and/or shafts.

In some embodiments, the power opening system comprises a combination of mechanical and electrical components. In some embodiments, the power opening system comprises a rack and pinion mechanism. In some embodiments, the power opening system comprises a rack and pinion mechanism and a nitrogen-powered mechanism. In some embodiments, a user may mechanically open the cover 10, one or more main panels 13, and/or one or more access panels 3 a certain amount, after which point the power opening system takes over and continues to open the cover 10, one or more main panels, and/or one or more access panels until the cover, the one or more main panels, and/or the one or more panels is/are completely open. In some embodiments, as an example, a user may mechanically open the cover 10, one or more main panels 13, and/or one or more access panels 13 to a predefined number of degrees, e.g., 30 degrees, after which point the power opening system takes over and continues to open the cover 10, one or more main panels 13, and/or one or more access panels 3 until completely open. In alternative embodiments, the user may open the cover 10, main panel 13, and/or access panel 3 a different amount before the power opening system takes control of the opening process.

In some embodiments, the truck bed cover system comprises at least one support element 40 constructed and arranged to support the at least one main panel 13 or at least one access panel 3 when the at least one panel is in an open position. In some embodiments, the at least one support element 40 can comprise one or more locks, stop, and/or detents for securing the support element in place in one or more predetermined positions. In various embodiments, the support element can take the form of a piston, bar, rod, brace, folding bar or linkage, or other holding device, which can form part of the cover system and be configured to hold and/or prop open the access panels and/or main panels. In other embodiments a support element can take the form of or include at least one hinge, such as a stay hinge, that is configured to support a panel in an open position.

FIG. 3B shows an example of a support element 40 used to support an open access panel. In FIG. 3B, panel 3f is held with a piston, bar, or brace 40. In various embodiments, the support element can take the form of hinges 34, 15, which may be stay hinges and/or lid support stay hinges. In FIG. 3B, access panels 3b, 3d are maintained in an open position via stay hinges 34.

FIGS. 4A-4C are rear views of the cover system 100 of FIGS. 1A-1C, in accordance with aspects of inventive concepts. In the embodiment shown in FIG. 4A, the truck bed cover system 100 comprises a first support element in the form of a first support brace 40a constructed and arranged to support and secure the first panel 13A when the first panel 13A is in an open position. In the embodiment shown in FIG. 4A, the truck bed cover system 100 comprises a second support element in the form of a second support brace 40b constructed and arranged to support and secure the second main panel 13B when the second main panel 13B is in an open position.

In some embodiments, such as the embodiment shown in FIG. 4A, the support brace 40 comprises a base 41 and an extension 42, the extension 42 being configured to telescopically extend from the base 41. In the embodiment shown in FIG. 4, both the first support 40a and the second support brace 40b comprise a base 41a, 41b and a corresponding extension 42a, 42b. In various embodiments, the support braces 40 can be pistons. FIGS. 4B and 4C show similar brace arrangements for their respective covers 10.

In some embodiments, the truck bed cover system 100 can comprise one or more lights mounted at an interior surface of the cover 10. In some embodiments, the truck bed cover system 100 comprises one or more lights mounted at an interior surface of at least one panel 3. In the embodiment shown in FIG. 4B, the truck bed cover system 100 comprises one light 43 mounted at an interior surface of the left panel 13L. In alternative embodiments, the truck bed cover system 100 comprises a different number of lights 43. In some embodiments, one or more of the one or more lights 43 are configured to turn on when the cover 10 and/or panel 13 is open. In some embodiments, one or more of the one or more lights 43 are configured to turn on when the cover 10 and/or panel 13 is completely opened and/or at least partially opened. In some embodiments, one or more of the one or more lights 43 are configured to blink. In some embodiments one or more access panels can include a light.

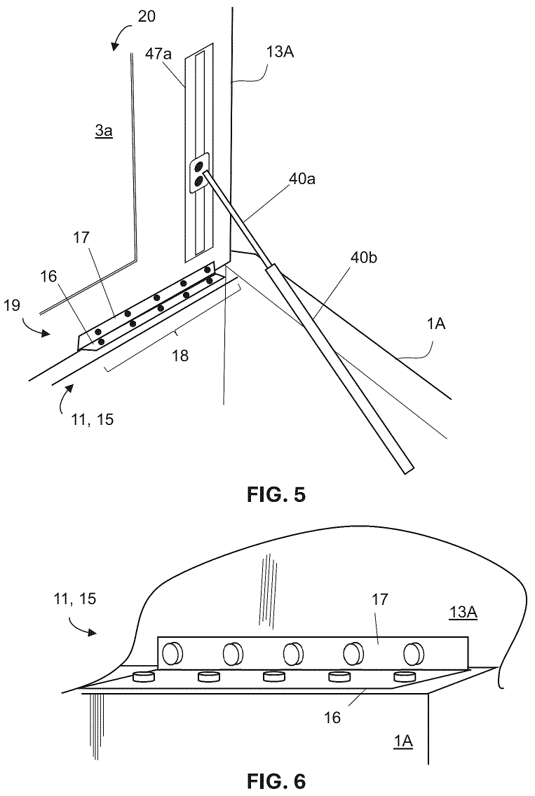

Referring to FIG. 5, in some embodiments, the truck bed cover system 100 comprises at least one cover attachment mechanism 11 constructed and arranged to couple the one or more main panels to the truck 1 or truck bed 1A. In some embodiments, the cover attachment mechanism 11 is constructed and arranged to removably couple the one or more main panels to the truck 1 or the truck bed 1A. In some embodiments, the cover attachment mechanism 11 is constructed and arranged to couple the one or more main panels to a side panel of the truck 1, which forms part of the bed 1A. In some embodiments, the panel attachment mechanism 11 comprises one or more detachable hinges, e.g., hinges 15, that enable the cover 10, the cover system 100, and/or one or more main panels to detachably remove from the truck bed 1A. In some embodiments, the cover attachment mechanism 11 comprises one or more piano hinges. In some embodiments, the cover attachment mechanism 11 comprises one, two, three or more piano hinges with removable pins to facilitate removal of the cover 10, the cover system 100, and/or one or more main panels. In some embodiments, other types of hinges can be used. In alternative embodiments, the panel attachment mechanism may comprise alternative attachment mechanisms that are not hinges. For example, in some embodiments, the attachment mechanism can include any other type of rotation-enabling mechanisms presently known or hereafter developed, including rotating arm mechanisms.

In some embodiments, the main panels can be configured to detach from the cover 10 or cover system 100 without rotation, such as with clips or fasteners. In some embodiments, a plurality of clips or fasteners can be distributed at edges 7A-7D (see FIG. 3C) of the cover and/or main panels to enable the cover and/or main panels to be removed from the cover system and/or truck bed. In some embodiments, the main panels can be configured to slide open and closed relative to the cover.

In the embodiment of FIG. 5, there is shown the support brace 40a, at least one rail 47a, and a cover attachment mechanism 11, in accordance with aspects of inventive concepts. In this embodiment, the cover attachment mechanism 11 is the same as the panel attachment mechanism. In this embodiment, the cover attachment mechanism 11 comprises at least one hinge 15. In this embodiment the hinge 15 comprises a first portion 16 configured to couple to the truck 1 and a second portion 17 configured to couple to the first panel 13A of the cover 10. A similar configuration can be coupled to the second panel 13B. The first portion 16 is coupled to the truck via truck fasteners 18. The second portion 17 is coupled to the first panel 13A via cover fasteners 19. In some embodiments, the truck fasteners 18 are the same type as the cover fasteners 19. The truck fasteners 18 and/or cover fasteners 19 could be pins, screws, clips, bolts, or any suitable mechanism for coupling two surfaces together.

In some embodiments, such as the one shown in FIG. 5, the rail 47a is coupled to the main panel 13A. In some embodiments, such as the one shown in FIG. 5, the support brace 40a is configured to mate with the rail 47a such that a distal end of the support brace 40a can glide along and/or within the rail 47a as the panel 13A is opened and closed. In some embodiments, the distal end of the support brace 40a includes or is coupled to a toggle nut or glide that is configured to travel within the rail 47a as the main panel 13A opens and closes.

FIG. 6 is a perspective view of an embodiment of the hinge 15 of the cover attachment mechanism 11 of FIG. 5, in accordance with aspects of inventive concepts.

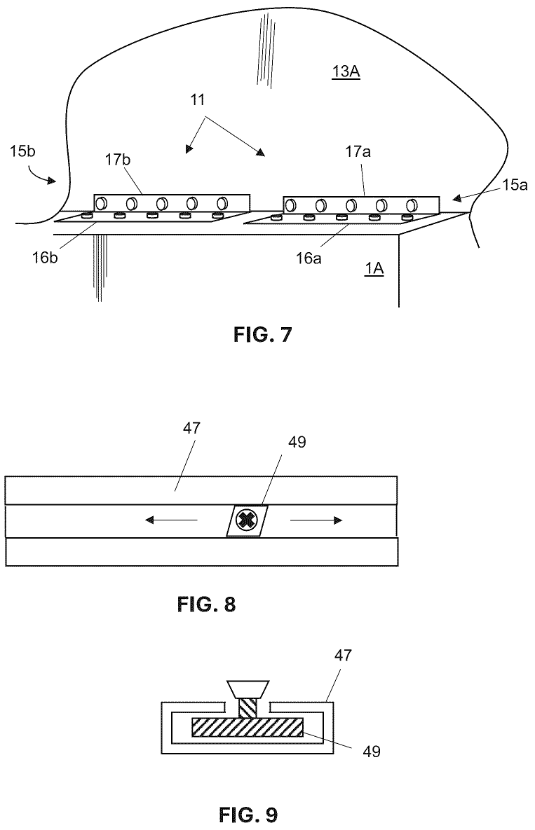

FIG. 7 is a perspective view of an embodiment of a cover attachment mechanism 11 of FIG. 5, including a plurality of hinges 15 used to couple a main panel 13A to the truck bed 1A of truck 1, in accordance with aspects of inventive concepts. In the view shown in FIG. 7 there are two hinges 15a, 15b. The first hinge 15a comprises a first portion 16a coupled to the truck bed 1A and a second portion 17a coupled to the main panel 13A. The second hinge 15b comprises a first portion 16b coupled to the truck bed 1A and a second portion 17b coupled to the main panel 13A.

FIG. 8 is a top view of an embodiment of a rail 47 of FIG. 5 comprising a channel, in accordance with aspects of inventive concepts. In the embodiment shown in FIG. 8, a toggle nut 49 is disposed within the rail 47. In some embodiments, a screw is coupled to the toggle nut 49 to slidingly attach an item, such as a distal end of the brace 40, to the rail 47. When the toggle nut 49 is disposed within the channel of the rail the toggle nut can linearly travel within the rail. When the distal end of the brace 40 is attached to the toggle nut, the brace 40 causes the toggle nut to travel within the rail as the main panel is opened and closed.

FIG. 9 is a cutaway end view of an embodiment of the rail 47 of FIGS. 5 and 8, in accordance with aspects of inventive concepts. In the embodiment shown in FIG. 9, the toggle nut 49 is disposed within the rail 47 so that the toggle nut 49 can travel within the rail 47. In some embodiments, a screw is coupled to the toggle nut 49 to couple a item, such as an end of a brace 40, to the toggle nut.

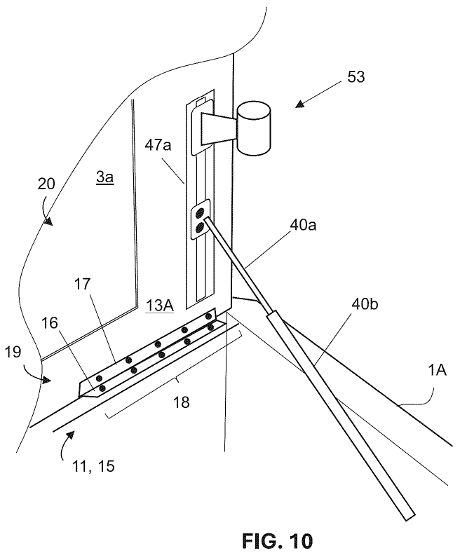

FIG. 10 is a perspective view of an embodiment of a mount 53, in accordance with aspects of inventive concepts. In some embodiments, the mount 53 can be coupled to the rail 47. In various embodiments, the mount 53 can be configured to removably couple to the rail 47. Additionally, or alternatively, in various embodiments, the mount 53 can include a based configured travel along and/or within the channel of the rail 47 such that the mount 53 can be moved along the rail to different locations and then secured in place. In some embodiments, such as the one shown in FIG. 10, the mount is constructed and arranged to hold an item, such as an extension bar, hook, light, and/or other accessory. In the embodiment shown in FIG. 10, the mount 53 is coupled to a rail 47 of the first main panel 13A. In alternative embodiments, the mount 53 or a similar mount may be coupled to the second main panel 13B.

In some embodiments, the truck bed cover system 100 comprises more than one rail. In the embodiment shown in FIGS. 5 and 10, the rail 47 is oriented near the front and along the top of the first main panel 13A. In alternative embodiments, the rail 47 can be oriented differently. For example, in alternative embodiments, the rail 47 can be near the middle of a panel 13. In alternative embodiments, the rail 47 is near the rear and along a bottom of a panel 13. In various embodiments, as an example, a rail can be mounted to a top end or edge and a bottom end or edge of a panel.

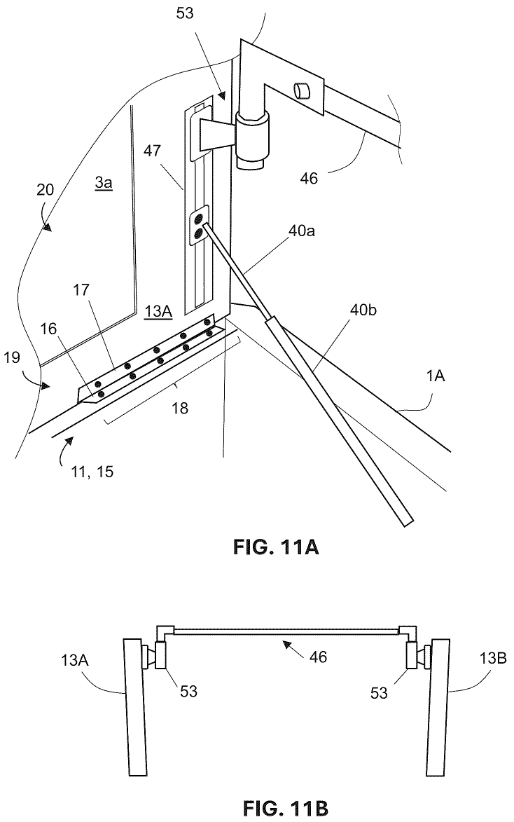

FIG. 11A is a perspective view of a portion of a bar 46 coupled to the mount 53 of main panel 13B, in accordance with aspects of inventive concepts. In the embodiment shown in FIG. 11A, the adjustable mount 53 is mounted to the rail 47 of the first main panel 13A and similarly mounted to an adjustable mount 53 and rail 47 of the second main panel 13B. In some embodiments, the bar 46 is constructed and arranged to support one or more items. In the embodiment shown in FIG. 11A, the truck bed cover system 100 comprises one bar 46. In alternative embodiments, the truck bed cover system 100 comprises a different number of bars 46. In some embodiments, at least one bar 46 is coupled to a panel 13 at a different position than shown. In some embodiments, the mounts 53 can be adjusted within their respective rails 47 to adjust a height of the bar 46. In some embodiments, at least one bar 46 is configured to fold up when not in use. In some embodiments, the at least one bar 46 is configured to telescopically extend and retract. In various embodiments, the bar 46 is removably coupled between two opposing main panels, such as main panels 13A and 13B, via respective mounts 53, which may or may need be adjustable.

FIG. 11B is a rear view of the bar 46 of FIG. 11A extending across the truck bed 1A, in accordance with aspects of inventive concepts. In the embodiment shown in FIG. 11B, one end of the bar 46 is coupled to the first panel 13A and the other end of the bar 46 is coupled to the second panel 13B. In this configuration, the bar can hold the two panels open, thereby vertically extending the sides of the truck bed and the truck bed volume 2.

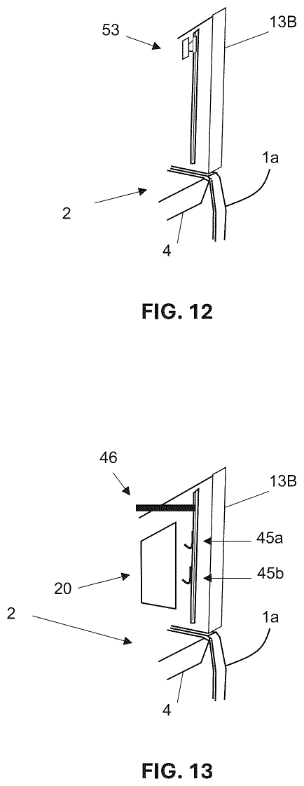

FIG. 12 is a rear view of an embodiment of a mount coupled to a rear end or edge of a panel, in accordance with aspects of inventive concepts. In the embodiment shown in FIG. 12, an adjustable mount 53 is mounted at a rail 47 at the rear, or tail gate end, of second panel 13B. In various embodiments, a corresponding adjustable mount 53 may be mounted to the rear, or tail gate end, of the first panel 13A. Thus, unlike the embodiments shown in FIGS. 10-11, in FIG. 12 the rail 47 is mounted near the rear of the truck bed 1A. A bar 46 could similarly be disposed in mounts of both main panels 13A, 13B at the rear of the cover system 100 and truck 1, as an alternative to or in addition to, the bar 46 at the front end of the truck.

FIG. 13 is a rear perspective view of an embodiment of the truck bed cover system 100, in accordance with aspects of inventive concepts. In the embodiment shown in FIG. 13, the cover 10 comprises two main panels 13A, 13B. In the view shown in FIG. 13, the second panel 13B is in a raised or open position, such that it does not enclose the truck bed volume 2.

In the embodiment shown in FIG. 13, the first main panel 13A comprises an aperture 20 and a corresponding access panel 3 is constructed and arranged to allow selective access through the aperture 20 and into the truck bed volume 2 when the access panel is open. The access panel 3 can be coupled to the first main panel 13A using an access panel attachment mechanism 34, as discussed above, which can comprise at least one hinge that enables the access panel to open the access panel.

In some embodiments, the truck bed cover system 100 comprises at least one bar 46 constructed and arranged to support hanging one or more items. In the embodiment shown in FIG. 13, the truck bed cover system 100 comprises a single bar 46. In alternative embodiments, the truck bed cover system 100 comprises a plurality of bars 46. In the embodiment shown in FIG. 13, the bar 46 is coupled to the second main panel 13B. In alterative embodiments, at least one bar 46 can be coupled to the first main panel 13A. In some embodiments, at least one bar 46 is disposed at a different position of a main panel 13. In some embodiments, at least one main panel includes at least one bar 46 that is configured to fold up when not in use. In some embodiments, at least one of the at least one bar 46 is configured to telescopically extend and retract. In some embodiments, at least one access panel 3 can comprise a bar or other accessory.

In some embodiments, the truck bed cover system 100 comprises at least one hook 45, as a different type of accessory, which can be constructed and arranged to support hanging one or more items from the truck bed cover system 100. In the embodiment shown in FIG. 13, the truck bed cover system comprises two hooks 45a, 45b. In alternative embodiments, the truck bed cover system 100 comprises a different number of hooks 45. In the embodiment shown in FIG. 13, the hooks 45a, 45b are coupled to the second main panel 13B. In alterative embodiments, at least one of the at least one hook 45 is coupled to the first panel 13A. In some embodiments, at least one of the at least one hook 45 is at a different position of the main panel 13. In some embodiments, at least one of the at least one hooks 45 is configured to rotate. In some embodiments, at least one of the at least one hooks 45 is configured to lock its position. In some embodiments, the at least one hook 45 is coupled to a rail 47 mounted at an inner surface of the main panel 13. In some embodiments, the at least one hook 45 is coupled to a rail 47 mounted at an inner surface of the cover 10. In some embodiments, at least one hook can be configured to couple to a plurality of main panels forming part of the cover 10 and/or cover system 100.

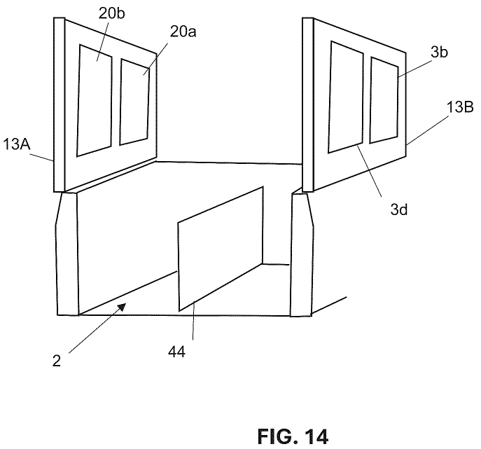

FIG. 14 is a rear perspective view of an embodiment of a truck bed cover system 100, in accordance with aspects of inventive concepts. The embodiment shown in FIG. 14 has the characteristics described in connection with the other embodiments. In addition, in the embodiment shown in FIG. 14, the truck bed cover system 100 comprises a partition 44 constructed and arranged to divide the truck bed volume 2 into different segments. In the embodiment shown in FIG. 14, the truck bed cover system 100 comprises one partition 44. In alternative embodiments, the truck bed covers system 100 may comprise a different number of partitions. In the embodiment shown in FIG. 14 the partition 44 is aligned in a direction parallel with a longitudinal axis of the truck. In alterative embodiments, the partition 44 may be aligned differently. In some embodiments, the partition 44 is positioned so that it aligns with the dimensions of at least one panel 13. In some embodiments, the partition 44 is positioned so that it aligns with the dimensions of at least one access panel 3. In some embodiments, the partition 44 may be rotatable. In some embodiments, the partition 44 is constructed and arranged to form a water-tight seal with a corresponding panel 13. In some embodiments, the partition 44 is constructed and arranged to form a water-tight seal with a corresponding access panel 3. In various embodiments, the cover and/or a main panel and/or an access panel can include one or more partitions, where a plurality of partitions can form a compartment within the truck bed volume that is accessible by at least one main panel and/or at least one access panel.

In various embodiments, the cover and main panels are oriented parallel to the horizontal when coupled to the truck bed and with the cover and main panels in the closed positions, as is shown in FIGS. 1-14. This orientation is also substantially 90 degrees with respect to the sides of the truck bed, or with respect to a vertical axis.

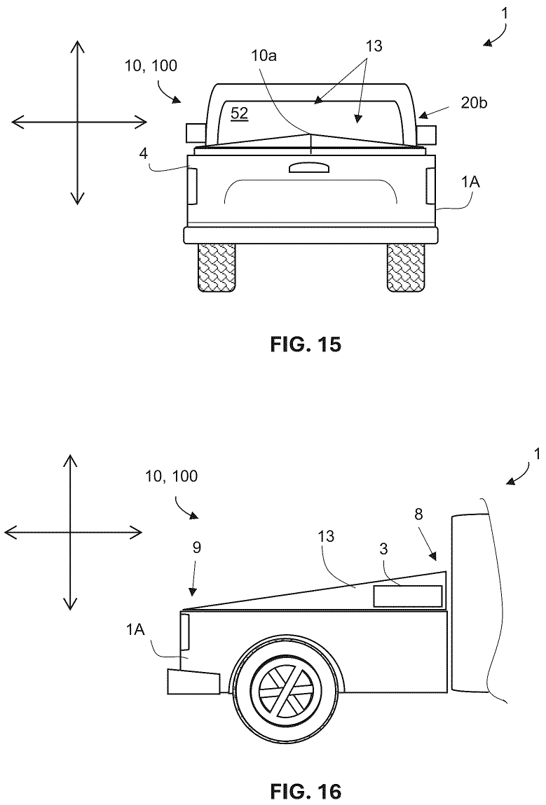

FIG. 15 is a rear view of an embodiment of a truck bed cover system 100, in accordance with aspects of inventive concepts. In various embodiments, such as that of FIG. 15, the cover and/or its main panels can be at different angles with respect to the horizontal and vertical axes. In the embodiment of FIG. 15, the cover and main panels, when moving from the sides of the truck bed toward the center of the truck bed, are oriented at more than 0 degrees and less than 90 degrees relative to the horizontal. In the embodiment of FIG. 15, the cover and main panels, when moving from the sides of the truck bed toward the center of the truck bed, are oriented at more than 90 degrees and less than 180 degrees relative to the vertical.

In some embodiments, such as the one shown in FIG. 15, the cover 10 comprises a raised center that forms slopes that move water towards the edges. In various embodiments, the main panels 13 could be angled upward from the sides of the truck 1 toward the center of the truck bed 2, as is shown. In some embodiments, a highpoint of the raised center can be along a raised longitudinal axis 10a. In some embodiments, the raised longitudinal axis 10a can run along or be the same as the centerline of the truck bed, as shown in FIG. 1A. In some embodiments, the raised longitudinal axis 10a can parallel, and offset right or left from, the centerline of the truck bed, as shown in FIG. 1A. In some embodiments, the raised center can comprise a raised point, where the cover 10 can have a pyramid shape.

FIG. 16 is a side view of an embodiment of a truck bed cover system 100, in accordance with aspects of inventive concepts. In various embodiments, such as that of FIG. 16, the cover and/or its main panels can be at different angles with respect to the horizontal and vertical axes. In the embodiment of FIG. 16, the cover and main panels, when moving from the tailgate or rear of the truck bed toward the front of the truck bed, are oriented at more than 0 degrees and less than 90 degrees relative to the horizontal. In the embodiment of FIG. 16, the cover and main panels, when moving from the tailgate or rear of the truck bed toward the front of the truck bed, are oriented at more than 90 degrees and less than 180 degrees relative to the vertical.

In some embodiments, the cover 10 comprises a first end 8 and a second end 9 and the first end 8 is raised relative to the second end 9. The cover can include one or more main panels 13 and one or more access panels 3.

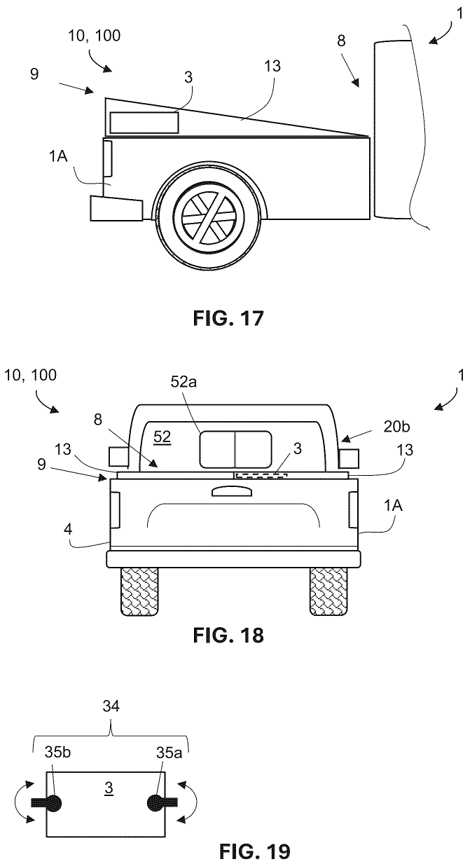

FIG. 17 is a side view of an embodiment of a truck bed cover system 100, in accordance with aspects of inventive concepts. In some embodiments, the cover 10 comprises a first end 8 and a second end 9 and the second end 9 is raised relative to the first end 8. The cover can include one or more main panels 13 and one or more access panels 3.

FIG. 18 is a rear view of an embodiment of a truck bed cover system 100, in accordance with aspects of inventive concepts. In some embodiments, the cover 10 comprises a first end 8 and a second end 9, and at least one access panel 30 positioned near the first end 8 and the center of the cover 10. In some embodiments, the vehicle 1 comprises a cab window 52. In some embodiments, at least one access panel 30 is positioned near the first end 8 and the center of the cover 10 so that a person may reach through the cab window 52 to access the access panel 30.

FIG. 19 is a rear perspective view of an embodiment of a truck bed cover system 100, in accordance with aspects of inventive concepts. In the embodiment shown in FIG. 19, the truck bed cover system 100 comprises one aperture 20 and a corresponding access panel 30. In this embodiment, the access panel is removably coupled to the cover 10.

In some embodiments, the access panel attachment mechanism 34 comprises at least one rotatably catch 35 coupled to a corresponding knob. When inserting the access panel 3 into the main panel 13 or cover 10, the rotatable catch 35 is configured so that it does not extend beyond the dimensions of the access panel 3. Once the access panel 3 is in position at the main panel 13 or cover 10, the knob is rotated so that the catch 35 extends beyond the dimensions of the access panel 3 and locks the access panel 3 in place. In this embodiment, the access panel attachment mechanism 34 comprises two catches 35a, 35b. In alternative embodiments, the access panel attachment mechanism 34 comprises a different number of catches. In some embodiments, each catch 35 is mated with a corresponding knob. In some embodiments, one knob controls more than one catch 35. In alternative embodiments, at least one of the at least one catch 35 is at a different position.

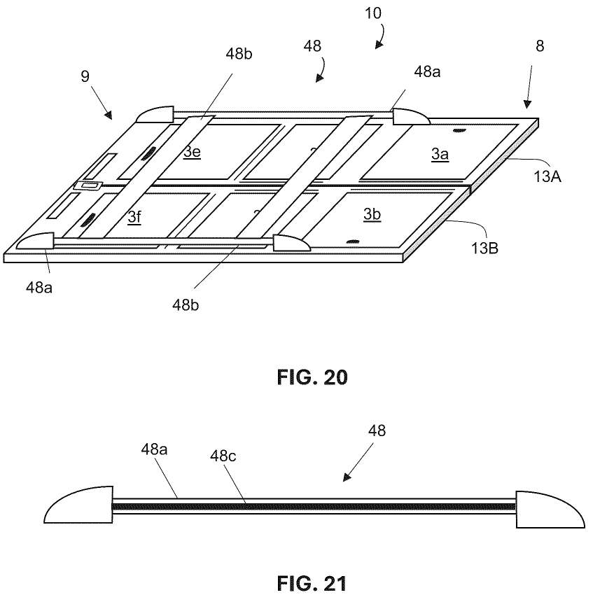

FIG. 20 is a perspective view of an embodiment of a truck bed cover system 100, in accordance with aspects of inventive concepts. In some embodiments, the cover 10 may be a cover similar to the cover of the embodiments of FIGS. 1A and 3C, but further comprises one or more racks 48 for storing items. In some embodiments, the cover 10 comprises one or more racks 48 configured to store one or more skis. In some embodiments, the cover 10 comprises one or more racks 48 configured to store one or more bikes. In some embodiments, the cover 10 comprises one or more racks configured to store one or more kayaks. In some embodiments, the cover 10 comprises one or more racks 48 to store one or more toolboxes. In the embodiments shown, the rack includes two main beam 48a that couple to the tow main panels 13, 13B and can further include two cross beams 48b that couple to the main beams 48a. In some embodiments, the positions of the cross beams 48b, or their separation, can be adjustable relative to the main beams 48a, e.g., by traveling with tracks of the main beams.

FIG. 21 is a side view of an embodiment of a rack 48 with cross beam mounting slots 48c for mounting one or more items, in accordance with aspects of inventive concepts. In some embodiments such a rack 48 is mounted to the cover and/or to one or more panels 13.

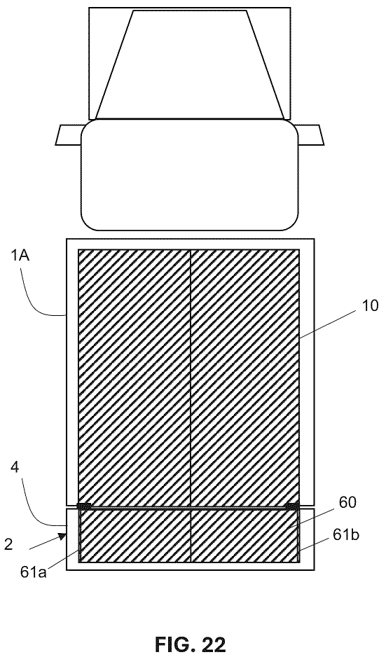

FIG. 22 is a top view of a bed extender cover 60, in accordance with aspects of inventive concepts. In some embodiments, the vehicle 1 comprises a bed extender constructed and arranged to be coupled to the vehicle when the tailgate 4 of the vehicle 1 is lowered. The truck bed cover system 100 may comprise a bed extender cover 60 constructed and arranged to cover the additional truck bed volume 2 that is created through the use of the bed extender. In some embodiments, the bed extender cover 60 covers a top surface of the additional truck bed volume 2. In some embodiments, the truck bed cover system 100 comprises one or more bed extender side covers 61 that cover one or more sides of the additional truck bed volume 1. In some embodiments, the bed extender cover 60 folds up against the undersides of the cover 10 and extends out over the lowered tailgate.

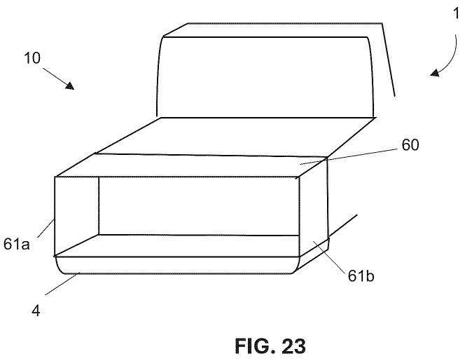

FIG. 23 is a perspective view of a bed extender cover 60 and bed extender side covers 61 of FIG. 22, in accordance with aspects of inventive concepts. In the embodiment shown, there are two bed extender side covers 61, one that covers the left side 61a and one that covers the right side 61b. Each of the bed extender side covers 61a, 61b is coupled to the bed extender cover 60. In some embodiments one or more of the one or more bed extender side covers 61 are removably coupled to the bed extender cover 60. In alternative embodiments, there may be only one bed extender side cover 61. In alternative embodiments, there may not be a bed extender side cover 61 coupled to the bed extender cover 60. In some embodiments, there may be a bed extender side cover 61 that covers the rear side of the truck bed volume 2.

While the foregoing has described what are considered to be the best mode and/or other preferred embodiments, it is understood that various modifications can be made therein and that the inventive concepts may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the invention which are, for brevity, described in the context of a single embodiment may also be provided separately or in any suitable sub-combination.

For example, it will be appreciated that all of the features set out in any of the claims (whether independent or dependent) can be combined in any given way.

What is claimed is:

1. A truck bed cover system, comprising:
a cover comprising at least one panel configured to enclose a truck bed volume of a truck bed; and
the at least one panel including at least one access panel configured to selectively provide access to the truck bed volume when enclosed by the at least one panel.

2. The system of claim 1, wherein the at least one panel comprises a plurality of panels, wherein each of the plurality of panels covers a portion of the truck bed volume.

3. The system of claim 2, wherein the cover comprises a plurality of panels, at least one panel from the plurality of panels comprises a plurality of access panels.

4. The system of claim 2, further comprising a securing mechanism for securing at least one of the plurality of panels to another one of the plurality of panels.

5. The system of claim 1, further comprising a cover attachment mechanism constructed and arranged to removably couple the cover to the truck.

6. The system of claim 1, wherein one or more panels from the at least one panel is coupled to the cover via a rotatable attachment mechanism.

7. The system of claim 6, wherein one or more panels from the at least one panel is configured to rotate open relative to the cover toward a truck bed center.

8. The system of claim 1, wherein one or more access panels from the at least one panel is coupled to a corresponding access panel via a rotatable attachment mechanism.

9. The system of claim 8, wherein one or more access panels from the at least one access panel is configured to rotate open relative to its corresponding panel toward a truck bed center.

10. The system of claim 1, wherein the at least one access panel is removably coupled to the at least one panel.

11. The system of claim 1, wherein the at least one panel comprises at least one aperture and each access panel is configured to selectively cover a corresponding aperture.

12. The system of claim 1, wherein the at least one access panel comprises a securing mechanism configured to secure a position of the at least one access panel relative to the at least one panel.

13. The system of claim 1, wherein the cover forms a water-tight seal with the truck bed.

14. The system of claim 1, wherein the cover comprises a raised region near a center of the cover to move water towards the edges.

15. The system of claim 1, further comprising at least one mount coupled to the at least one panel, each mount constructed and arranged to hold an accessory.

16. The system of claim 15, wherein the at least one panel includes a left panel and a right panel that rotate open outward from a centerline of the truck bed, each panel including at least one mount, wherein the accessory comprises a bar having a first end that couples to a mount of the left panel and a second end that couples to a mount of the right panel.

17. The system of claim 15, wherein the accessory comprises at least one storage rack.

18. The system of claim 15, wherein the accessory comprises at least one rail configured to receive at least one removable hook and/or at least one removable extender bar.

19. The system of claim 1, wherein the at least one panel comprises panel that includes a light.

20. A truck bed cover system, comprising:
a cover configured to couple to and enclose a truck bed volume of a truck bed, the cover comprising:
a first panel rotatably hinged to the cover and comprising at least one first access panel that is rotatably hinged to the first panel; and
a second panel rotatably hinged to the cover and comprising at least one second access panel that is rotatably hinged to the second panel,
wherein the first panel is configured to rotate away from a centerline of the truck bed volume and the second panel is configured to rotate away from the centerline of the truck bed volume in a direction opposite the first panel.
